(19) United States
(12) Patent Application Publication
(10) Pub. No.: US 2008/0129026 A1
(43) Pub. Date: Jun. 5, 2008

(54) Apparatus and method for sensing displacement

(75) Inventors: Matthew James Gray, Brighton, MI (US); Laura Catherine Shoop, St. Joseph, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/607,188

(22) Filed: Dec. 1, 2006

(51) Int. Cl. B60R 21/0132; G01B 7/14; G01G 7/02

(52) U.S. Cl. 280/735; 177/210 EM; 324/207.13; 324/207.2; 340/667

(57) ABSTRACT

A displacement sensor (12) having an elongated member (128) having a conical shaped bellows portion (132) collapsible in response to applied force along an axis (116) of the elongated member. A sensor (126, 142) is located within the bellows portion (132) of the elongated member (128) for providing an electrical signal indicative of the applied force.

### TECHNICAL FIELD

The present invention is directed to an apparatus and method for sensing displacement and, more particularly, to a method and apparatus for sensing displacement of a portion of a vehicle seat cushion resulting from weight of an occupant on the vehicle seat, the vehicle having an actuatable occupant restraining system.

### BACKGROUND OF THE INVENTION

Information regarding occupant size and/or position in an automobile is useful for control of various subsystems of the automobile including control of the occupant restraining system. For example, an airbag control system may adjust deployment of the airbag based upon the position of the occupant relative to the airbag and the weight of the occupant. The airbag control system may control the airbag by controlling timing and gas volume. U.S. Pat. No. 5,494,311, issued to Brian K. Blackburn et al. on Feb. 27, 1996 and assigned to TRW Vehicle Safety Systems Inc. shows an array of sensors located within the seat to detect and calculate the occupant's approximate weight and position on the seat and controls the airbag in response thereto.

### SUMMARY OF THE INVENTION

In accordance with one aspect of the present invention, a displacement sensor is provided having an elongated member having a conical shaped bellows portion collapsible in response to applied force along an axis of the elongated member. A sensor is located within the bellows portion of the elongated member for providing an electrical signal indicative of the applied force.

In accordance with another aspect of the present invention, a seat displacement sensor assembly for measuring a displacement of an automobile seat is provided comprising an elongated member having a conical shaped bellows portion collapsible in response to applied force along an axis of the elongated member. A sensor is located within the elongated member and provides an electrical signal indicative of the amount of the collapse of the bellows portion and, it turn, the applied force. The displacement sensor assembly further includes a seat pad mounted in the vehicle seat. The elongated member is mounted to the seat pad. Weight on the seat collapses the bellows and the electrical signal from the sensor is indicative of weight on the seat.

In accordance with yet another aspect of the present invention, an automobile seat apparatus is provided comprising a seat back and a seat bottom connected with the seat back and having a seating surface side and a bottom side longitudinally spaced from the seating surface side by an interior portion. At least one sensor cavity extends into the interior portion from at least one of distal and proximal sides of the seat bottom. A seat mat associated with the seat bottom is provided and has electrical connections. A seat displacement sensor assembly is provided including an assembly base attachable to the seat mat; a sensor located within the assembly base; and a bellows assembly having a first bellows portion, a second bellows portion, and a central axis. The second bellows portion is attachable to the assembly base and compressible supports the first bellows portion in a position biased away from the assembly base along the central axis, and a cross-section of the bellows assembly has an axial cross-section that varies according to the position of the cross-section along the central axis. Part of the sensor is carried by the first bellows portion.

In accordance with yet a further aspect of the present invention, a method of assembling a seat displacement sensor to measure force on a seat is provided comprising the steps of providing an elongated member having a collapsible conical shaped bellows portion, mounting a sensor in said bellows portion to measure said collapse, mounting said elongated member to a seat pad, providing a sensor cavity in the seat bottom, inserting the elongated member into the sensor cavity, applying pressure to the seat bottom, and processing the sensor signal to determine the force on the seat.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a side view of part of an automobile with a seat assembly having displacement sensors made in accordance with an example embodiment of the present invention;

FIG. 2 is a perspective view of one of the displacement sensors of FIG. 1 made in accordance with the one example embodiment of the present invention;

FIG. 3 is a sectional side view of the seat displacement sensor of FIG. 2 taken along line 3-3;

FIG. 4 is a combined axial cross-sectional view taken along line 4-4 of FIG. 3;

FIG. 5 is a combined axial cross-sectional view taken along line 5-5 of FIG. 3;

FIG. 6 is a combined axial cross-sectional view taken along line 6-6 of FIG. 3;

FIG. 7 is a combined axial cross-sectional view taken along line 7-7 of FIG. 3;

FIG. 8 is an exploded perspective view of the seat displacement sensor of FIG. 2;

FIG. 9 is a perspective view of a displacement sensor made in accordance with another example embodiment of the present invention; and,

FIG. 10 is a partial sectional side view of the displacement sensor of FIG. 9.

### DETAILED DESCRIPTION

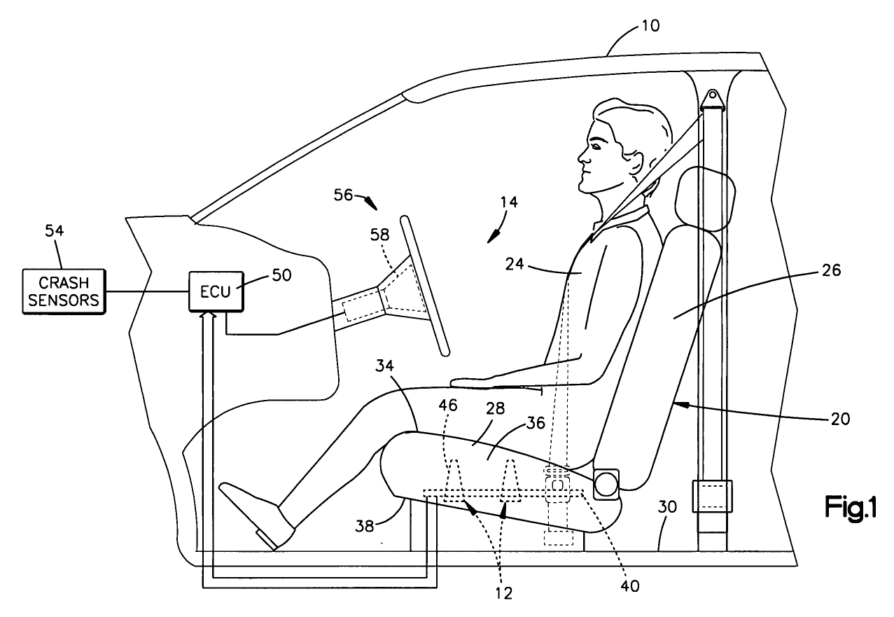

Referring to FIG. 1, a vehicle 10 includes an apparatus 12 for sensing displacement, in accordance with an example embodiment of the present invention. In accordance with a particular application, the displacement sensor 12 is used as part of an occupant weight and position sensing arrangement in a vehicle occupant restraining system 14 of the vehicle 10. The vehicle 10 includes a seat 20, such as the driver's seat, upon which, a driver 24 would sit. The seat 20 has two parts including a seat back 26 and a seat bottom 28. The seat bottom 28 is movably secured to the vehicle floor 30 either for manual seat positioning (e.g., mechanical sliding of the seat 20) or for electrical seat positioning (e.g., electric motors move the seat 20).

The seat bottom 28 includes a top seating surface 34, an interior seat portion 36, and a bottom seat side 38. The interior seat portion 36 may be made of foam or another cushion material. Located within the interior seat portion 36 is a plurality of the displacement sensors 12 referred to as an array of sensors 12. Each displacement sensor 12 is secured to a mounting pad 40. The mounting pad 40 is also located within the interior seat portion 36 or may be mounted to the bottom side 38 of the seat bottom 28. The mounting pad 40 is located at a depth or position in the seat 28 so that application of weight upon the seating surface 34, e.g., driver 24 sets on the seat 28, does not result in vertical movement of the pad 40 relative to the floor 30.

In accordance with this particular application of the present example embodiment, each displacement sensor 12 of the sensor array is received in an associated sensor cavity opening 46 within the interior seat portion 36 of the seat bottom 28. Each displacement sensor has a general conical shape with a central axis. Each sensor cavity opening 46 is in the same conical shape and location to receive its associated displacement sensor 12 and has an axis that extends in a direction generally normal to the bottom side 38 toward the seating surface 34 of the seat bottom 28. The sensor cavity openings 46 may be formed during manufacture of the seat bottom 28 or may be formed later such as by a drilling or boring process.

When a load is place on the vehicle seat bottom 28, e.g., a driver 24 sits on the seat 20, his weight causes the seat surface 34 to be displaced downward toward the bottom seat surface 38 causing compression of the interior seat portion 36. Each displacement sensor 12 of the sensor array affected by the weight is adapted to axially collapse downward in response to this applied weight and to provide an electrical signal indicative of the amount of displacement, i.e., axial displacement, it experiences. In effect, each of the displacement sensors 12 measure the amount of displacement it senses as a result of a load being placed on the seat 28. This is dependent on weight and position of the object. Using an appropriate algorithm in combination with an array of sensors 12 dispersed in the seat 20, the occupant's weight and/or position on the vehicle seat 20 can be determined.

To accomplish occupant weight and/or position determinations for an occupant restraining system 14, an electrical output from each displacement sensor 12 is connected to an electronic control unit (“ECU”) 50 of the occupant restraining system 14. Each sensor 12 is electrically connected to the pad 40 which has electrical traces that connect to an electrical connector. This connector then is connected to the ECU 50. The ECU 50 is also connected to crash sensors 54 and to an actuatable restraining device 56 such as an airbag 58. Other actuatable restraining devices could also be included such as actuatable pretensioners, knee bolsters, side airbags, etc. The ECU 50 controls actuation of the airbag 58 (and any other included actuatable restraining devices) in response to signals from the crash sensors 54 and in response to occupant weight and/or position determined from the array of displacement sensors 12 in the driver's seat bottom 28. Those skilled in the art will appreciate that several known control algorithms could be used and that control of a passenger's side airbag could be similarly achieved. Control of multi-stage airbags using the displacement sensors of the present invention is also contemplated as is control of other actuatable restraints such as side airbags, roll-over airbags, side curtains, etc.

Such a control algorithm may use the array of displacement sensors to determine weight and/or position of the object on the seat 20 and use that information to classify the object as an animate or inanimate object. Assuming that the control algorithm determines that the object is a person, it then determines if the person a certain class person, such as a 75% male. It may then determine his position based on the sensor output such as whether the person is setting toward the left side of the seat. Based on this information, deployment, if needed, will be appropriately tailored.

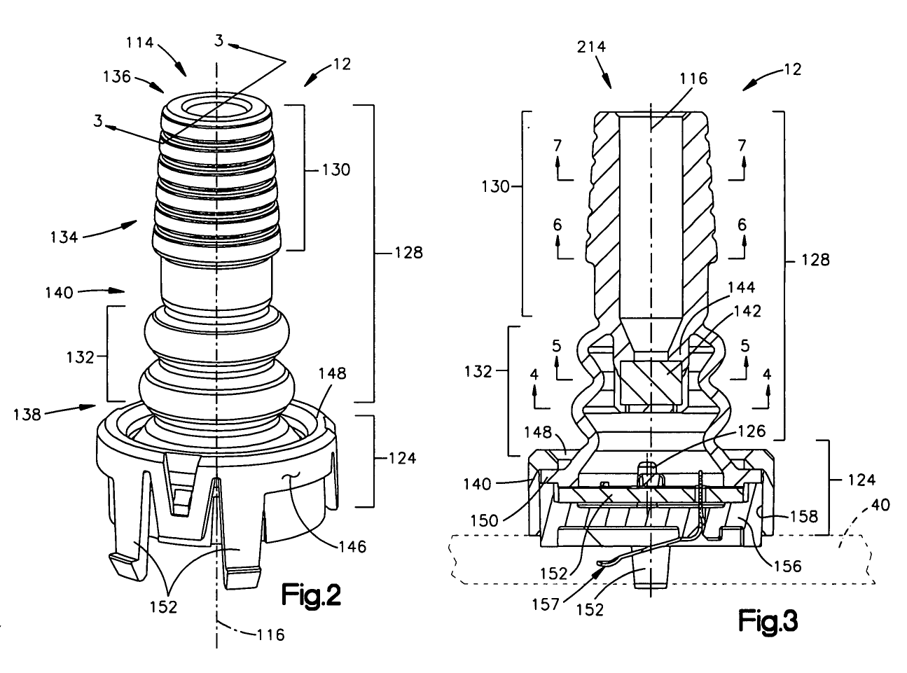

Referring to FIGS. 2-8, the seat displacement sensor assembly 12, made in accordance with one example embodiment of the present invention, will be better appreciated. The seat displacement sensor assembly 12 includes a base assembly portion 124. A bellows assembly portion 128 is generally conical in shape and is attached to the base assembly portion 124. The displacement sensor assembly 12 uses a Hall Effect sensor including a magnet 142 carried by the bellows assembly portion 128 and a Hall Effect sensor 126 mounted in the base assembly portion 124. The Hall Effect sensor 126 outputs an electric signal indicative of the spacing between the sensor 126 and the magnet 142.

The base assembly portion 124 is attachable to the seat mat 40. The base assembly portion 124 may be either removably attached to the seat mat 40 or permanently attached to the seat mat 40. A sensor 126 is mounted in the base assembly portion 124 and is fixed relative to the seat mat 40 when the displacement sensor assembly 12 is fully assembled and mounted to the mat 40. The displacement sensor assembly 12, including the bellows assembly portion 128 and the base assembly portion 124, has a central axis 116. A first portion 130 of the bellows assembly 128 is substantially rigid. A second portion 132 of the bellows assembly 128 is sufficiently resilient so as to structurally deform upon application of a compressive force applied to the bellows assembly 128 in a direction along the central axis 116 and then regains its original form after the compressive force is removed, i.e., applies a bias force pushing the first portion 130 away from the base portion 124. The first bellows portion 130 and the second bellows portion 132 are axially spaced along the central axis 116 and joined together. The joint may be integral or attached by other means. The bellows assembly 128, in accordance with the one example embodiment of the present invention, is formed as a one-piece unitary element, by a molding process or other suitable method. Alternatively, the first bellows portion 130 may be formed of a first material and the second bellows portion 132 may be formed of a second material, different from the first material, with the first bellows portion 130 and the second bellows portion 132 attached together. The material of the first and second bellows portions 130 and 132 need not be homogenous; for instance, reinforcing threads or the like could be provided within the first and/or second bellows portions 130, 132, respectively, to provide the necessary different properties, i.e., rigidity of the first portion 130 and the resilient compressibility of the second portion 132.

The conical shape of the displacement sensor assembly 12 in combination with the associated sensor cavity 46 in the seat bottom 36, substantially restrict non-axial motion of the second bellows portion 132, i.e., motion not along the axis 116, when the displacement sensor assembly 12 is subjected to force due to an object on the seat. Therefore, while the displacement sensor is subject to collapse in the axial direction 116, it resists movement in the transverse direction. Such an arrangement improves the accuracy of the output signal from the displacement sensor assembly 12.

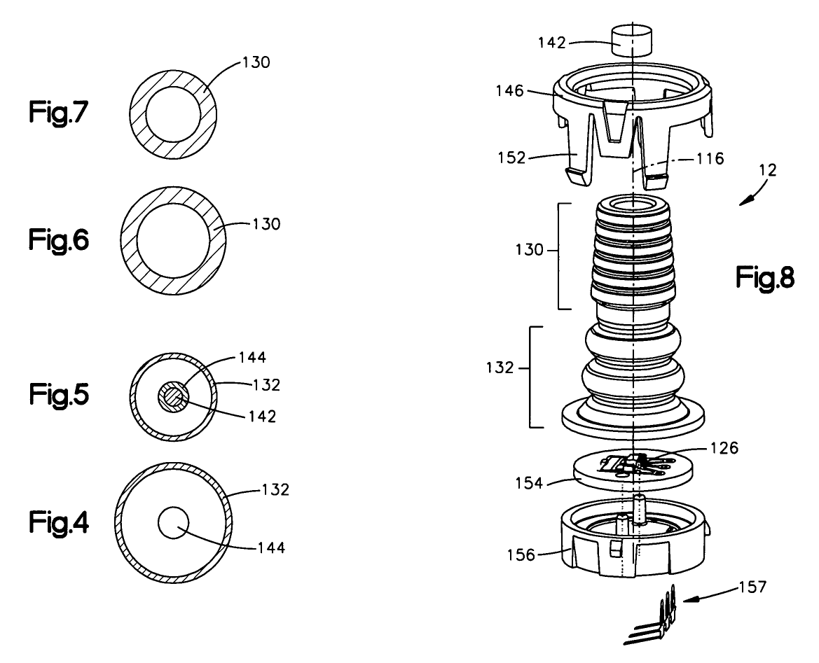

The cross-sectional views of the bellows assembly 128 shown in FIGS. 4-7 show the variable cross-sectional thicknesses and shapes of the walls of the first bellows portion 130 and the second bellows portion 132. For instance, the first bellows portion 130 includes a first bellows proximal portion 134 located proximate to the assembly base 124 and a first bellows distal portion 136 spaced apart from the first bellows proximal portion 134 along the central axis 116. The second bellows portion 132 includes a second bellows proximal portion 138 located proximate to the assembly base 124 and a second bellows distal portion 140 spaced apart from the second bellows proximal portion 138 along the central axis 116.

As shown in FIGS. 4 and 5 by the cross-sectional views, the first and second bellows portions 130 and 132 taper such that the axial cross-sections of the first and second bellows distal portions 136 and 140 are smaller than the axial cross-sections of the first and second bellows proximal portions 134 and 138, respectively. The axial cross-sections taken along lines 4-4, 5-5, 6-6, and 7-7 are not, however, to be construed as defining the first and second bellows distal portions 136 and 140 and first and second bellows proximal portions 134 and 138, respectively, but merely serve as visual guides to the differing areas and outlines of these bellows portions 130, 132, 134, and 138 in the example embodiment of the Figs. Likewise, none of the Figs. are drawn to scale; the relative proportions of the axial cross-sections shown in FIGS. 4-7 are intended only to show the relationships between elements of the seat displacement sensor assembly 12 and not to represent actual proportions or sizes of the elements depicted.

As shown in FIGS. 2, 3, and 8, the structure of the bellows assembly 128 may be operative to resiliently resist a compressive force applied in the direction of the central axis 116. For example, the second bellows portion 132 depicted in FIGS. 2, 3, and 8 compressively supports the first bellows portion 130 while biasing the first bellows portion 130 in direction away from the mat 40. This support and bias is provided by the second bellows portion 132 through use of a resilient yet collapsible structure which is characterized by an axial cross-section which varies in a generally alternating manner along the central axis 116, as seen best in FIGS. 2, 3, and 8.

The structure of the second bellows portion 132 is adapted to resiliently resist a compressive force experienced by the first bellows portion 130 by resiliently collapsing in a longitudinal manner. However, the second bellows portion 132 is resilient enough to return to the original configuration upon removal of the compressive force. As shown in FIGS. 2, 3, and 8, the bellows structure of the bellows assembly 128 may have any suitable arrangement resulting in a desired variance of axial cross-sections. The bellows assembly 128 may generally taper along the central axis 116 as shown in the Figs. such that the larger of the alternating axial cross-sections in the second bellows distal portion 140 are smaller, on average, than the larger alternating axial cross-sections in the second bellows proximal portion 138.

Varying materials, wall thicknesses, diameters, and axial structure variations of the bellows assembly 128 may be selected to achieve the desired force versus compression function. In the example embodiment, the bellows assembly 128 is formed as a hollow tube, as shown in FIGS. 2-8. The first and second bellows portions 130 and 132 may have substantially the same wall thicknesses. The wall thickness of the second bellows portion 132, however, may be less than the wall thickness of the first bellows portion 130 to make the second bellows portion 132 more likely than the first bellows portion 130 to collapse under compressive force applied along the central axis 116.

The Hall Effect sensor 126 has an associated magnet 142 secured to the first bellows portion 130 by a magnet holding extension portion 144 formed as part of the first bellows portion 130. In accordance with one example embodiment, the extension portion 144 is integrally formed with the bellows portion 130. In an uncompressed state, i.e., no compression force is applied to the assembly 128, the magnet 142 is a predetermined distance from the sensor 126. In this non-compressed condition, the sensor 126 outputs a first voltage value. As compressive force is applied to the bellows assembly 128, the second bellows portion 132 collapses and the magnet 142 moves toward the sensor 126. As the magnet distance changes relative to the sensor 126, the output voltage changes. Therefore, the output voltage from the sensor 126 is indicative of the force applied to the displacement sensor 126 and the displacement experienced by the displacement sensor assembly 12. In the example embodiment of FIGS. 2-8, the wall thickness and structure of the first bellows portion 130 is chosen to substantially resist deformation from a longitudinal compressive force in the direction of the central axis 116. Therefore, a magnet 142 supported by the first bellows portion 130 (via the magnet holding extension portion 144) will move longitudinally about the same amount as does the first bellows portion 130 under the longitudinal compressive force. The controlled collapse occurs due to the second bellows portion 132. The sensor 126 provides a displacement signal responsive to the distance between the magnet 142 and the sensor 126, which, in turn, is functionally related to the compressive force on the bellows assembly 128.

As shown in FIG. 3, the magnet extension portion 144 extends into the second bellows portion 132. The magnet extension portion 144 has a smaller diameter than the inside of the second bellows portion 132 so as not to bind or interfere with a desired collapsing of the second bellows portion 132.

The components of the seat displacement sensor assembly 12 are assembled together to provide efficiencies in manufacturing and repair of the seat assembly 20 and any related automobile subassemblies, such as the aforementioned airbag control system. Namely, at least the bellows assembly 128, sensor 126, magnet 142, and the assembly base 124 are provided as a single seat displacement sensor assembly 12 unit. Thus, manufacture or repair of the seat assembly may be readily accomplished by a simple operation of merely inserting the seat displacement sensor assembly 12 into the sensor cavity 46 and connecting the seat displacement sensor assembly 12 to the seat mat 40. A mechanical and/or electrical connection between the seat displacement sensor assembly 12 and the seat mat 40 is accomplished through engagement of the bellows assembly 128 and/or an assembly base 124 with the seat mat 40.

In accordance with one example embodiment, the assembly base 124 has a snap ring 146 adapted to encircle at least a portion of the bellows assembly 128, and a snap rim 148 formed as a distal portion of the snap ring 146 and having a snap rim circumference smaller than a lip circumference 150 of the bellows assembly 128. A plurality of engagement hooks 152 of the assembly base 124 are connected with the snap ring 146 and extend through and attach to the seat mat 40 to hold the seat displacement sensor assembly 12 to the seat mat 40. The engagement hooks 152 may be formed integrally with the snap ring 146, and may be located on the snap ring 146 in a longitudinally spaced relationship with the snap rim 148. The engagement hooks 152 may be removably attachable to the seat mat 40, or may instead be adapted for one-time use, such as when mechanical connection of the seat displacement sensor assembly 12 with the seat mat 40 requires an irreversible deformation of the engagement hooks 152.

The snap ring 146 of the assembly base 124 in the example embodiment engages with the bellows assembly 128 by engaging the snap rim 148 with the lip circumference 150 of the bellows assembly 128, as shown in FIGS. 2, 3, and 8. Once the assembly base 124 and the bellows assembly 128 are assembled together, the sensor 126 may be inserted into the assembly base 124 to form the seat displacement sensor assembly 12. Optionally, the snap ring 146 of the assembly base 124 and the bellows assembly 128 cooperatively enclose the sensor 126. This enclosure need not be through direct contact, but the snap ring 146 and bellows assembly 128 may surround the sensor 126 within the seat displacement sensor assembly 12 to both position and protect the sensor 126 in a desired manner.

As shown in FIGS. 3 and 8 a printed circuit board 154 may be provided within the assembly base 124. The printed circuit board 154 may support the sensor 126. The printed circuit board 154 may also serve to enclose the sensor 126, in cooperation with the assembly base 124 and the bellows assembly 128. The seat mat 40 has all the electrical connections in the form of electrical connection traces build in. Each displacement sensor assembly 12 electrically connects to the seat mat 40 through its compliant electrical pins 157 connected to the sensor 126. The mat 40 is then connected to the electronic control unit 50 via an external connector and cable. The assembly base 124 may include a PCB ring 156 adapted to hold the printed circuit board 154 within the assembly base 124. The PCB ring 156 extends inward from a snap ring circumference 158 and may optionally be formed integrally as a part of the assembly base 124 or may be a separate piece, e.g., a press-fit disk or hoop inserted into the assembly base 124 after the printed circuit board 154. Alternately, the printed circuit board 154 may be structurally adapted to function as a PCB ring 156 and hold itself within the assembly base 124, either alone or with the assistance of a fastener, adhesive, a structure of the assembly base, or other suitable attachment means.

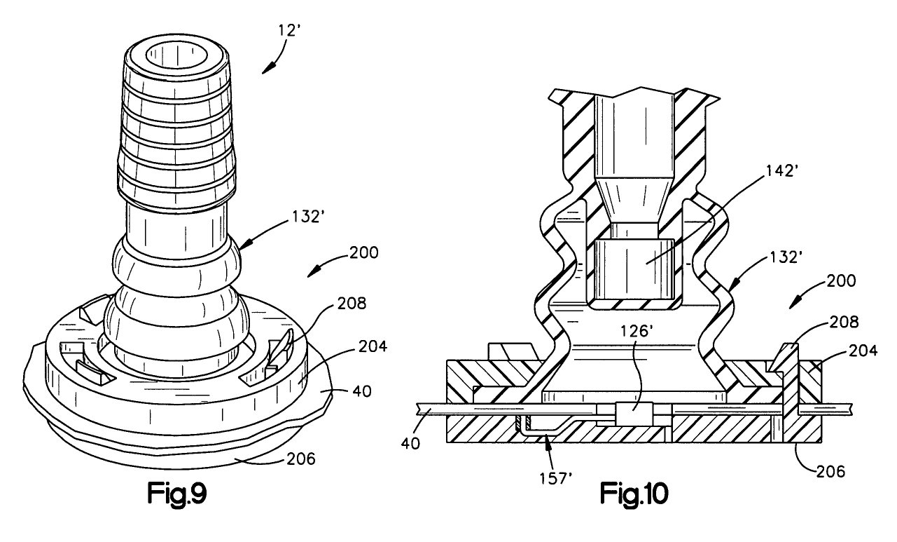

Referring to FIGS. 9 and 10, another example embodiment of the present invention is shown. In accordance with this example embodiment, the displacement assembly sensor 12′ is secured to the seat mat 40 using a base assembly 200. The base assembly 200 includes first plate 204 that fits over the second bellows portion 132′ and holds flanges of the second bellows portion 132′ against the seat mat 40. The base assembly 200 includes a second member 206 that mounts from the other side of the mat 40 and includes toothed extension flanges 208 arranged to be received in associated openings in the mat 40 and received in flange openings in the first plate 204. Once the second member is pushed into the mat 40 and the two members 206 and 204 are pushed toward each other, the flanges 208 releasably lock the assembly 12 to the mat 40. In accordance with the example embodiment, three flanges 208 may be used. The Hall Effect sensor 126′ makes electrical connection with traces in the mat 40 via connectors 157′ which may be compliant pins that penetrate the pad upon assembly. The sensor 126′ could be attached to the second member 206 prior to assembly so that after assembly, its spacing relative to magnet 142′ will be fixed.

The structure and/or material selected for the bellows portion 132 may be selected so as to provide a desired force vs. displacement function. This may be either a linear or non-linear function. As will be appreciated, such desired force vs. displacement function yields a similar force vs. electrical output function so that the force vs. electrical output may be linear or non-linear as desired based on material and/or shaped selection of the bellows portion.

From the above description of the invention, those skilled in the art will perceive improvements, changes and modifications. Such improvements, changes and modifications within one skill of the art are intended to be covered by the appended claims.

Having described the invention, the following is claimed:

1. A displacement sensor comprising:
an elongated member having a conical shaped bellows portion collapsible in response to applied force along an axis of the elongated member; and
a sensor located within the bellows portion of the elongated member for providing an electrical signal indicative of the applied force.

2. The displacement sensor of claim 1 wherein sensor is a Hall Effect sensor.

3. The displacement sensor of claim 1 wherein at least one of said shape and material of said bellows is selected to provide a desired force versus collapse function of said elongated member.

4. The displacement sensor of claim 1 further including a resilient cover for receiving said elongated member, said cover having a commensurate shaped receiving bore for receiving said elongated member, said resilient cover being subject to displacement forces.

5. A seat displacement sensor assembly for measuring a displacement of an automobile seat, the seat displacement sensor assembly comprising:
an elongated member having a conical shaped bellows portion collapsible in response to applied force along an axis of the elongated member;
a sensor located within the elongated member and providing an electrical signal indicative of the amount of the collapse of said bellows portion and, it turn, the applied force; and
a seat pad mounted in the vehicle seat, said elongated member mounted to said seat pad and received in an elongated opening in said seat, weight on said seat collapsing said bellows, said electrical signal from said sensor being indicative of weight on said seat.

6. The seat displacement sensor assembly for measuring a displacement of an automobile seat of claim 5 wherein sensor is a Hall Effect sensor.

7. The seat displacement sensor assembly for measuring a displacement of an automobile seat of claim 5 further including an assembly base for securing said elongated member to said seat pad, said assembly base including:
a snap ring adapted to encircle the bellows portion;
a snap rim formed as a distal portion of the snap ring and having a snap rim circumference smaller than a lip circumference of the bellows portion;
at least one engagement hook connected with the snap ring and attachable to the seat pad; and
wherein the snap rim engages with the bellows portion, the snap ring encloses the sensor cooperatively with the bellows portion, and the engagement hook engages with the seat pad to hold the seat displacement sensor to the seat pad.

8. The seat displacement sensor assembly for measuring a displacement of an automobile seat of claim 5 further including a mounting base having a first mounting ring for holding the bellows portion to the seat pad and a second mount member with engagement flanges mounted from a second side of the seating pad, said flanges extending through said seating pad and locking onto said first mounting ring so as to hold said displacement sensor assembly to said seating pad.

9. An automobile seat apparatus, comprising:
a seat back;
a seat bottom connected with the seat back and having a seating surface side and a bottom side longitudinally spaced from the seating surface side by a interior portion;
at least one sensor cavity extending into the interior portion from at least one of the distal and proximal sides of the seat bottom;
a seat mat associated with the seat bottom and having electrical connections; and
a seat displacement sensor assembly, including:
an assembly base attachable to the seat mat;
a sensor located within the assembly base; and
a bellows assembly having a first bellows portion, a second bellows portion, and a central axis;
wherein the second bellows portion is attachable to the assembly base and compressibly supports the first bellows portion in a position biased away from the assembly base along the central axis, and a cross-section of the bellows assembly has a axial cross-section that varies according to the position of the cross-section along the central axis.

10. The automobile seat apparatus of claim 9, wherein the first and second bellows portions form the bellows assembly as a unitary piece.

11. The automobile seat apparatus of claim 9, wherein the second bellows member substantially prevents motion of the first bellows member in a direction transverse to the central axis.

12. The automobile seat apparatus of claim 9, wherein the sensor cavity is a cylindrical hole having a cross-sectional area which is substantially constant along the central axis.

13. A method of assembling a seat displacement sensor to measure force on a seat, the method comprising the steps of:
providing an elongated member having a collapsible conical shaped bellows portion;
mounting a sensor in said bellows portion to measure said collapse;
mounting said elongated member to a seat pad;
providing a sensor cavity in the seat bottom;
inserting the seat elongated sensor into the sensor cavity;
applying pressure to the seat bottom; and
processing the sensor signal to determine the force on the seat.
